(19) United States
(12) Patent Application Publication
(10) Pub. No.: US 2025/0374026 A1
(43) Pub. Date: Dec. 4, 2025

(54) SYSTEMS AND METHODS FOR BINDING INFORMATION TRANSMISSION WITH UNCREWED AUTONOMOUS VEHICLES

(71) Applicant: ZTE CORPORATION, Shenzhen (CN)

(72) Inventors: Yansheng LIU, Shenzhen (CN); Dapeng LI, Shenzhen (CN); Yin GAO, Shenzhen (CN); Jiren HAN, Shenzhen (CN)

(73) Assignee: ZTE CORPORATION, Shenzhen (CN)

(21) Appl. No.: 19/297,319

(22) Filed: Aug. 12, 2025

Related U.S. Application Data
(63) Continuation of application No. PCT/CN2023/077930, filed on Feb. 23, 2023.

(51) Int. Cl. H04W 8/00

(52) U.S. Cl. CPC H04W 8/005

(57) ABSTRACT

Aspects of this technical solution can include sending, by a first wireless communication entity to a second wireless communication entity, a first message, where the first message is indicative of binding a first wireless communication device to a second wireless communication device or unbinding the first wireless communication device from the second wireless communication device, receiving, by the first wireless communication entity from the second wireless communication entity, a second message acknowledging the first message.

### CROSS-REFERENCE TO RELATED APPLICATION

This application claims the benefit of priority under 35 U.S.C. § 120 as a continuation of PCT Patent Application No. PCT/CN2023/077930, filed on Feb. 23, 2023, the disclosure of which is incorporated herein by reference in its entirety.

### TECHNICAL FIELD

The disclosure relates generally to wireless communications and, more particularly, to binding information transmission with uncrewed autonomous vehicles (UAVs).

### BACKGROUND

Global interest for uncrewed aerial vehicles (UAV)-based services has dramatically increased. Based on plans by various governments to support urban aerial mobility (UAM) service, it is desired under 3GPP that legacy 5G NR devices, and not a UAV maintain data communication quality at sufficient level.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

At least one aspect is directed to a wireless communication method. The method can include sending, by a first wireless communication entity to a second wireless communication entity, a first message, where the first message is indicative of binding a first wireless communication device to a second wireless communication device or unbinding the first wireless communication device from the second wireless communication device. The method can include receiving, by the first wireless communication entity from the second wireless communication entity, a second message acknowledging the first message.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 depicts an example network architecture, in accordance with present implementations.

FIG. 4 depicts an example procedure for UAV and UE binding and unbinding, in accordance with present implementations.

FIG. 5 depicts an example binding configuration between a UAV and a UE, in accordance with present implementations.

FIG. 6 depicts an example binding configuration between a UAV and a UE, in accordance with present implementations.

FIG. 7 depicts an example unbinding configuration between a UAV and a UE, in accordance with present implementations.

FIG. 8 depicts an example binding information transmission with UAVs, in accordance with present implementations.

FIG. 9 depicts an example method of binding information transmission with UAVs, in accordance with present implementations.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

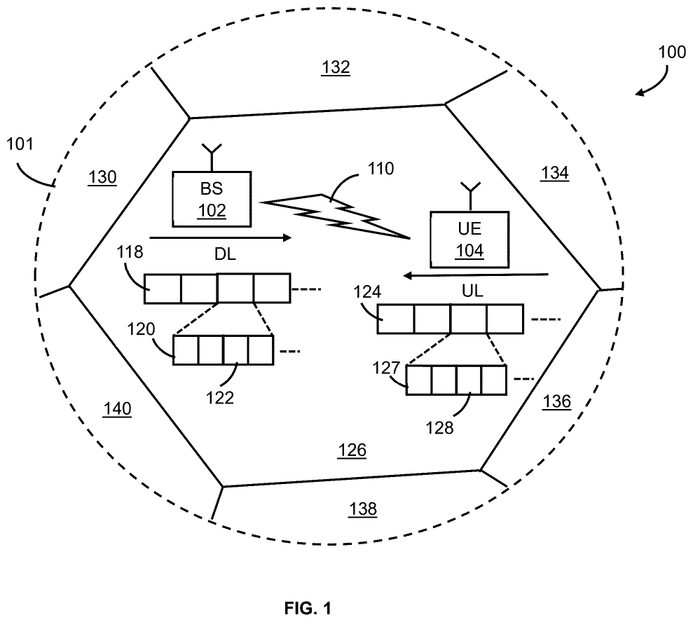

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support MIMO communication. For example, MIMO is a key technology in new radio (NR) systems. MIMO may be functional in both frequency division duplex (FDD) and time division duplex (TDD) systems, among others. MIMO technologies may utilize reporting mechanisms such as CSI to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more CQIs in the CSI report, the reference signals are aperiodic or semi-persistent, and each of a CSI window length, DD basic unit size, an offset between two CSI reference signal (CSI-RS) resources, and a length of DD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

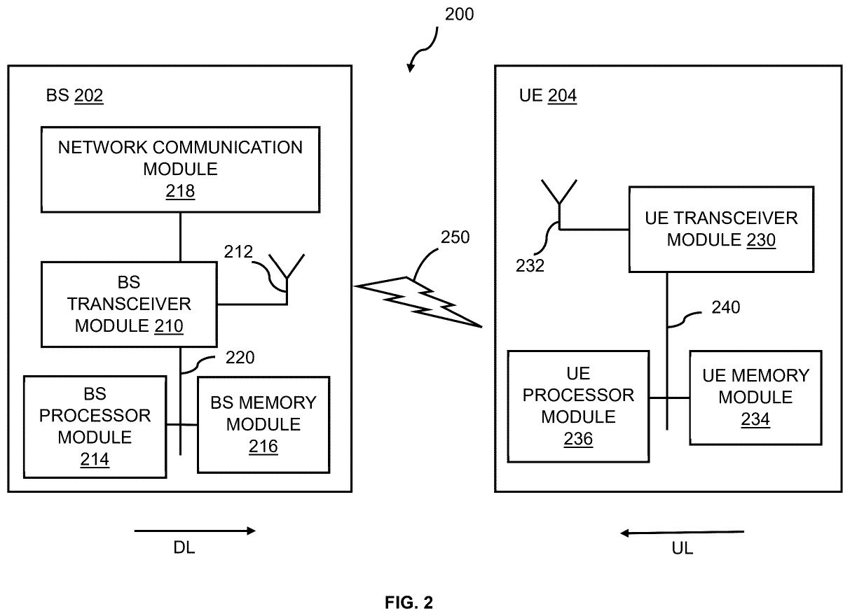

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

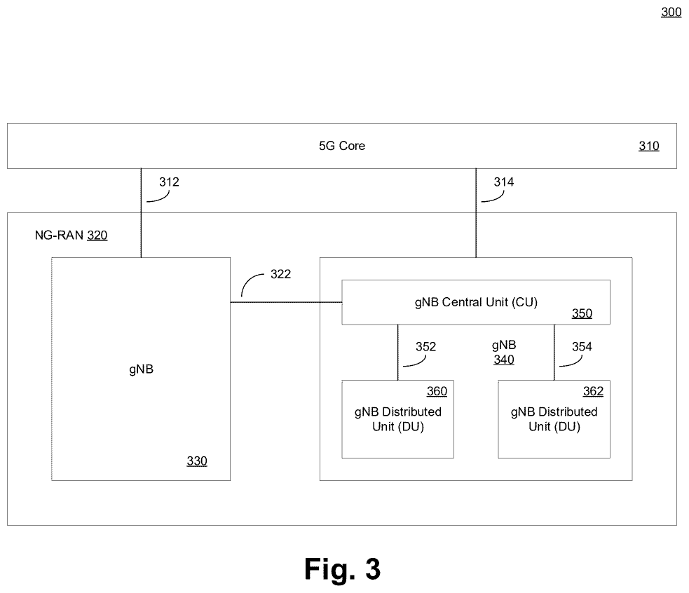

FIG. 3 depicts an example network architecture, in accordance with present implementations. As illustrated by way of example in FIG. 3, an example network architecture 300 can include at least a 5G core 310, NG communication channels 312 and 314, a NG-RAN 320, CU/DU communication channels 352 and 354, and gNB distributed units 360 and 362.

For example, FIG. 3 illustrates an overall architecture of a control unit/distributed unit CU/DU split. As shown, a 5G core network (5GC or AMF) and an NG-RAN node are connected via an NG interface. An Xn interface van connect different NG-RAN nodes. A gNB may include a gNB Central Unit (gNB-CU) and one or more gNB Distributed Units (gNB-DU). A gNB-CU and a gNB-DU can be connected via at least one F1 interface.

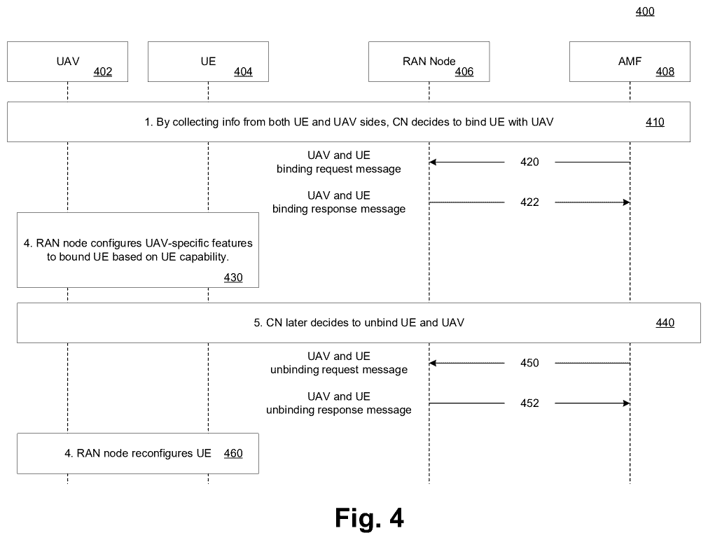

FIG. 4 depicts an example procedure for UAV and UE binding and unbinding, in accordance with present implementations. As illustrated by way of example in FIG. 4, an example procedure for UAV and UE binding and unbinding 400 can include at least an UAV 402, a UE 404, a RAN node 406, an AMF 408, a CN binding determination 410, a binding request message 420, a binding response message 422, a configuration by RAN node 430, a CN unbinding determination 440, an unbinding request message 450, an unbinding response message 452, and a configuration by RAN node 460.

For example, FIG. 4 illustrates an example procedure for UAV and UE binding and unbinding. The procedure can include a pre-condition. For example, the UE in this call flow can be a type of legacy UE in NR. More specifically, the UE can correspond to a Rel-15/16/17 UE, or not correspond to a UAV UE for Rel-18. For example, a specification lack UAV features.

For example, by collecting info from both UE side and UAV side, a CN can determine that a particular is UE may follow this UAV for a period of time (e.g., UE is on broad, or UE wired connects to the UAV, or UE is inside the UAV as an attachment, etc.), and decides to bind the UE with the UAV. Next, for example, the AMF sends the message to the UE's serving RAN node with the UAV and UE binding info. Next, for example, a RAN node receives the request message and replies ACK message. Next, for example, by receiving the binding request information, the RAN node may configure the UE some UAV specific features (e.g., on measurement, mobility, etc.) based on UE's capability when UE keeps the binding status. For example, after a period of time, the CN can decide to unbind the UAV with the UE (e.g., UE leaves the UAV). Next, for example, the AMF sends the message to the UE's serving RAN node with the unbinding info. Next, for example, the RAN node receives the request message and replies with an ACK message to the AMF. Next, for example, the RAN node may re-configure the UE based on UE's unbinding status.

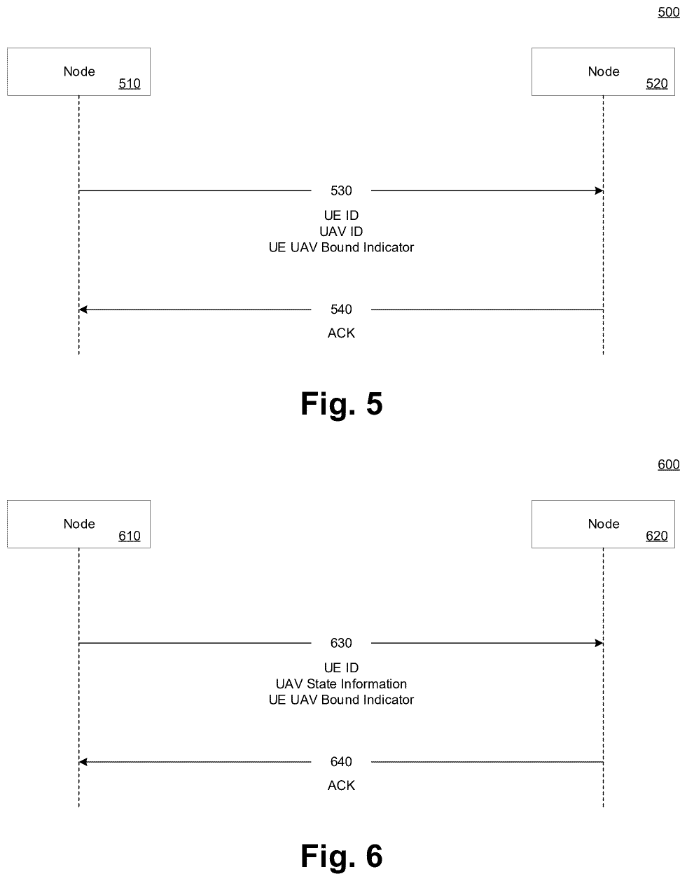

FIG. 5 depicts an example binding configuration between a UAV and a UE, in accordance with present implementations. As illustrated by way of example in FIG. 5, an example binding configuration between a UAV and a UE 500 can include at least nodes 510 and 520, a binding communication 530, and an acknowledgement communication 540. Aspects of this technical solution are directed to a UAV UE binding configuration. For example, an indicator is used by a first node to notice a second node that a UE with a particular UE identifier (UE ID) is to bind with a UAV with a particular UAV identifier (UAV ID). For example, when the second node receives this information, the second node can treat the UE as a legacy UE with additional UAV features. The second node may determine to optimize the UE configuration from a point of view of the UAV if the second node is a NG-RAN node. Detail optimization may depend on UE capability (e.g., be responsive to a particular or different version of the UE) and/or node capability.

For example, at least one of the following can be contained in a message sent from the first node to the second node. The message can include a UE ID to indicate which UE is to bind with the UAV. The message can include a UAV ID to indicate which UAV is to bind with the UE. The message can include a UE-to-UAV binding indicator to indicate that the UE and UAV are to bind or are bound with each other. For example, the first node and the second node may correspond to various entities in a 3GPP network. The above procedure may be transported by using the existing procedures or new introduced procedures in different fields, and is not limited to the examples discussed herein. The modes mentioned above may stand for various entities in 3GPP network. The above procedure may be transported by using the existing procedures or new introduced procedures in different fields.

Aspects of this technical solution can be directed to an NG application protocol (NGAP). For example, the first node and the second node are respectively AMF and NG-RAN nodes. For example, where if the first node is an AMF, the second node is an NG-RAN node. For example, where the first node is an NG-RAN node, the second node is an AMF. For example, the first message and second message are NGAP messages. For example, one of the following procedures may be used for binding info transmission if the existing procedure is selected for this purpose:

TABLE 1

| First Message | Second Message |
|---|---|
| Initial Context Setup Request | Initial Context Setup Response |
| UE Context Modification Request | UE Context Modification Response |
| HANDOVER REQUEST | HANDOVER REQUEST ACKNOWLEDGE |
| UE CONTEXT SUSPEND REQUEST | UE CONTEXT SUSPEND RESPONSE |
| UE CONTEXT RESUME REQUEST | UE CONTEXT RESUME RESPONSE |

Aspects of this technical solution can be directed to an Xn application protocol (XnAP). For example, the first node and the second node are two NG-RAN nodes. For example, the first message and the second message are XnAP messages. The relationship of two NG-RAN nodes may be either source node and target node (in mobility scenario) or MN and SN (in DC case). For example, one of the following procedures may be used for binding info transmission if the existing procedure is selected for this purpose:

TABLE 2

| First Message | Second Message |
|---|---|
| HANDOVER REQUEST | HANDOVER REQUEST ACKNOWLEDGE |
| S-NODE MODIFICATION REQUEST | S-NODE MODIFICATION REQUEST |
| | ACKNOWLEDGE |
| S-NODE MODIFICATION REQUIRED | S-NODE MODIFICATION CONFIRM |
| S-NODE ADDITION REQUEST | S-NODE ADDITION REQUEST |
| | ACKNOWLEDGE |
| S-NODE CHANGE REQUIRED | S-NODE CHANGE CONFIRM |
| RETRIEVE UE CONTEXT REQUEST | RETRIEVE UE CONTEXT RESPONSE |
| PARTIAL UE CONTEXT TRANSFER | PARTIAL UE CONTEXT TRANSFER |
| | ACKNOWLEDGE |
| S-NODE CHANGE REQUIRED | S-NODE CHANGE CONFIRM |
| SGNB ADDITION REQUEST | SGNB ADDITION REQUEST |
| | ACKNOWLEDGE |
| SGNB MODIFICATION REQUEST | SGNB MODIFICATION REQUEST |
| | ACKNOWLEDGE |
| SGNB MODIFICATION REQUIRED | SGNB MODIFICATION CONFIRM |
| SGNB CHANGE REQUIRED | SGNB CHANGE CONFIRM |

Aspects of this technical solution can be directed to an F1 application protocol (F1AP). For example, if a first node is a gNB-CU, a second node is a gNB-DU. For example, if a first node is a gNB-DU, a second node is a gNB-CU. For example, the first message and second message are F1AP messages. UE info may be existing gNB-CU UE F1AP ID IE and/or gNB-DU UE F1AP ID IE. For example, one of the following procedures may be used for binding info transmission if the existing procedure is selected for this purpose.

TABLE 3

| First Message | Second Message |
|---|---|
| UE CONTEXT SETUP REQUEST | UE CONTEXT SETUP RESPONSE |
| UE CONTEXT MODIFICATION REQUEST | UE CONTEXT MODIFICATION RESPONSE |
| UE CONTEXT MODIFICATION REQUIRED | UE CONTEXT MODIFICATION CONFIRM |

FIG. 6 depicts an example binding configuration between a UAV and a UE, in accordance with present implementations. As illustrated by way of example in FIG. 6, an example binding configuration between a UAV and a UE 600 can include at least nodes 610 and 620, a binding communication 630, and an acknowledgement communication 640. Aspects are directed to a UAV UE binding configuration with UAV state information. For example, this aspect can be used if A second node does not know the UAV ID before this procedure. UAV state info is used for A second node to evaluate which UAV is the related UAV in this procedure and what kinds of UAV specific features can be configured to UE.

For example, an indicator is used by a first node to notice a second node that a UE (marked by UE info) is to bind with a UAV (with UAV state info). When a second node receives this information, the second node can treat this UE as a legacy UE with additional UAV features and may determine to optimize the configuration of the UE from UAV point of view if a second node is a NG-RAN node. Detail optimization may depend on UE capability (e.g., different version UE) and/or Node's capability in this procedure.

At least one of the following info can be contained in the message sent from the first node to the second node. The message can include UE info used to mark which UE can be bind with a UAV. For example, the UE info can vary for different first nodes and second nodes. The message can include UAV state info that may contain the UAV status information, (e.g., predicted/history flight path info, UAV height info, interference detection info, UAV subscription info, UAV speed info, etc.). The UAV state info can be used for a second node to evaluate which UAV is the related UAV in this procedure and what kinds of UAV-specific features may be configured to the UE. The message can include a UE-UAV binding indicator to indicate that the UE and UAV can bind with each other. The first node and second node mentioned above may stand for various entities in 3GPP network. The above procedure may be transported by using the existing procedures or new introduced procedures in different fields.

Aspects of this technical solution can be directed to an NG application protocol (NGAP). For example, a first node is AMF and a second node is NG-RAN node. For example, the first message and the second message are NGAP messages. For example, UE info may be defined as AMF UE NGAP ID IE and RAN UE NGAP ID IE. For example, one of the following may be used for binding information transmission if the existing procedure is selected for this purpose.

TABLE 4

| First Message | Second Message |
|---|---|
| Initial Context Setup Request | Initial Context Setup Response |
| UE Context Modification Request | UE Context Modification Response |
| HANDOVER REQUEST | HANDOVER REQUEST |
| | ACKNOWLEDGE |
| UE CONTEXT SUSPEND REQUEST | UE CONTEXT SUSPEND RESPONSE |
| UE CONTEXT RESUME REQUEST | UE CONTEXT RESUME RESPONSE |

Aspects of this technical solution can be directed to an Xn application protocol (XnAP). For example, a first node and a second node are two NG-RAN nodes. For example, the first message and second message are XnAP messages. For example, the relationship of these two NG-RAN nodes may be either source node and target node (in mobility scenario) or MN and SN (in NR-DC, EN-DC, or NE-DC cases). UE info may correspond to existing NG-RAN node UE XnAP ID IE. For example, one of the following may be used for binding information transmission if the existing procedure is selected for this purpose.

TABLE 5

| First Message | Second Message |
|---|---|
| HANDOVER REQUEST | HANDOVER REQUEST |
| | ACKNOWLEDGE |
| S-NODE MODIFICATION REQUEST | S-NODE MODIFICATION REQUEST |
| | ACKNOWLEDGE |
| S-NODE MODIFICATION REQUIRED | S-NODE MODIFICATION CONFIRM |
| S-NODE ADDITION REQUEST | S-NODE ADDITION REQUEST |
| | ACKNOWLEDGE |
| S-NODE CHANGE REQUIRED | S-NODE CHANGE CONFIRM |
| RETRIEVE UE CONTEXT REQUEST | RETRIEVE UE CONTEXT RESPONSE |
| PARTIAL UE CONTEXT TRANSFER | PARTIAL UE CONTEXT TRANSFER |
| | ACKNOWLEDGE |
| S-NODE CHANGE REQUIRED | S-NODE CHANGE CONFIRM |
| SGNB ADDITION REQUEST | SGNB ADDITION REQUEST |
| | ACKNOWLEDGE |
| SGNB MODIFICATION REQUEST | SGNB MODIFICATION REQUEST |
| | ACKNOWLEDGE |
| SGNB MODIFICATION REQUIRED | SGNB MODIFICATION CONFIRM |
| SGNB CHANGE REQUIRED | SGNB CHANGE CONFIRM |

Aspects of this technical solution can be directed to an F1 application protocol (F1AP). For example, if a first node is gNB-CU, a second node is gNB-DU. For example, if a first node is gNB-DU, a second node is gNB-CU. For example, the first message and the second message are F1AP messages. For example, UE info may be existing gNB-CU UE F1AP ID IE and/or gNB-DU UE F1AP ID IE. For example, one of the following procedures may be used for binding information transmission if the existing procedure is selected for this purpose. One of the following procedures may be used for binding info transmission if the existing procedure is selected for this purpose:

TABLE 6

| First Message | Second Message |
|---|---|
| UE CONTEXT SETUP REQUEST | UE CONTEXT SETUP RESPONSE |
| UE CONTEXT MODIFICATION | UE CONTEXT MODIFICATION |
| REQUEST | RESPONSE |
| UE CONTEXT MODIFICATION | UE CONTEXT MODIFICATION |
| REQUIRED | CONFIRM |

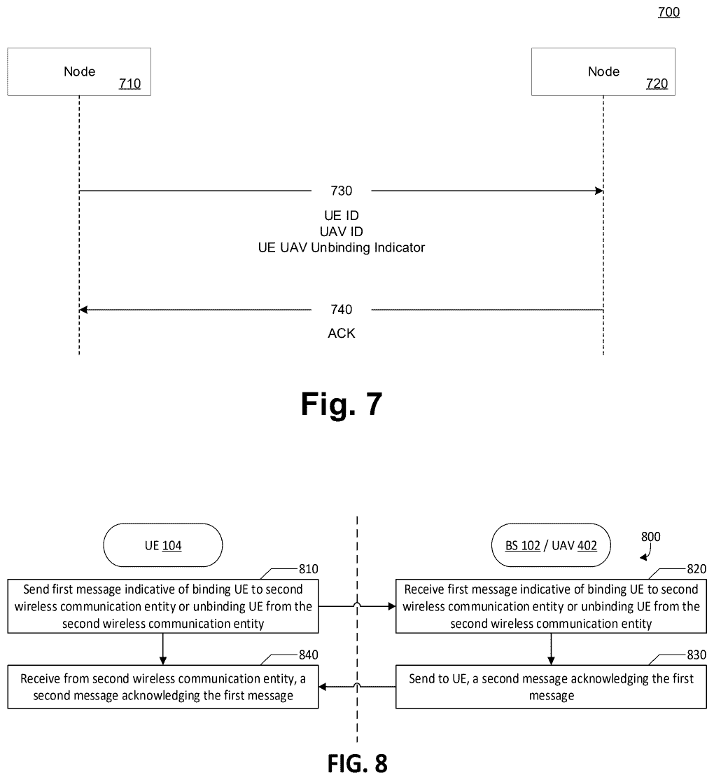

FIG. 7 depicts an example unbinding configuration between a UAV and a UE, in accordance with present implementations. As illustrated by way of example in FIG. 7, an example unbinding configuration between a UAV and a UE 700 can include at least nodes 710 and 720, an unbinding communication 730, and an acknowledgement communication 740. Aspects of this technical solution can be directed to a UAV UE unbinding configuration. For example, before an unbinding procedure, a UE and a UAV can be bound based on the received configuration, as discussed herein. In response to a change in state or a condition satisfaction (e.g., a UE leaves range of a UAV), a first node can send unbind information to a second node. For example, an indicator is used by a first node to notice a second node that a UE with a particular UE ID is unbound from a UAV with a particular UAV ID. When a second node receives this information, a second node can treat the particular UE as a legacy UE without any UAV features and may determine whether to modify the current configuration of the UE.

For example, at least one of the following can be contained in a message sent from a first node to a second node. The message can include a UE ID to indicate which UE is to bind with the UAV. The message can include a UAV ID to indicate which UAV is to bind with the UE. The message can include a UE UAV unbinding indicator to indicate that the UE and UAV are to be unbound. A first node and a second node mentioned above may stand for various entities in a 3GPP network.

Aspects of this technical solution can be directed to an NG application protocol (NGAP). For example, a first node is AMF and a second node is NG-RAN node. For example, the first message and the second message are NGAP messages. For example, one of the following may be used for binding information transmission if the existing procedure is selected for this purpose.

TABLE 7

| First Message | Second Message |
|---|---|
| HANDOVER REQUEST | HANDOVER REQUEST |
| | ACKNOWLEDGE |
| UE CONTEXT SUSPEND REQUEST | UE CONTEXT SUSPEND RESPONSE |
| UE CONTEXT RESUME REQUEST | UE CONTEXT RESUME RESPONSE |

Aspects of this technical solution can be directed to an Xn application protocol (XnAP). For example, a first node and a second node are two NG-RAN nodes. For example, the first message and second message are XnAP messages. For example, the relationship of these two NG-RAN nodes may be either source node and target node (in mobility scenario) or MN and SN (in NR-DC, EN-DC, or NE-DC cases). UE info may correspond to existing NG-RAN node UE XnAP ID IE. For example, one of the following may be used for binding information transmission if the existing procedure is selected for this purpose.

TABLE 8

| First Message | Second Message |
|---|---|
| HANDOVER REQUEST | HANDOVER REQUEST ACKNOWLEDGE |
| S-NODE MODIFICATION REQUEST | S-NODE MODIFICATION REQUEST |
| | ACKNOWLEDGE |
| S-NODE MODIFICATION REQUIRED | S-NODE MODIFICATION CONFIRM |
| S-NODE ADDITION REQUEST | S-NODE ADDITION REQUEST |
| | ACKNOWLEDGE |
| S-NODE CHANGE REQUIRED | S-NODE CHANGE CONFIRM |
| RETRIEVE UE CONTEXT REQUEST | RETRIEVE UE CONTEXT RESPONSE |
| PARTIAL UE CONTEXT TRANSFER | PARTIAL UE CONTEXT TRANSFER |
| | ACKNOWLEDGE |
| S-NODE CHANGE REQUIRED | S-NODE CHANGE CONFIRM |
| SGNB ADDITION REQUEST | SGNB ADDITION REQUEST |
| | ACKNOWLEDGE |
| SGNB MODIFICATION REQUEST | SGNB MODIFICATION REQUEST |
| | ACKNOWLEDGE |
| SGNB MODIFICATION REQUIRED | SGNB MODIFICATION CONFIRM |
| SGNB CHANGE REQUIRED | SGNB CHANGE CONFIRM |

Aspects of this technical solution can be directed to an F1 application protocol (F1AP). For example, if a first node is gNB-CU, a second node is gNB-DU. For example, if a first node is gNB-DU, a second node is gNB-CU. For example, the first message and the second message are F1AP messages. For example, one of the following procedures may be used for binding information transmission if the existing procedure is selected for this purpose.

TABLE 9

| First Message | Second Message |
|---|---|
| UE CONTEXT SETUP REQUEST | UE CONTEXT SETUP RESPONSE |
| UE CONTEXT MODIFICATION REQUEST | UE CONTEXT MODIFICATION RESPONSE |
| UE CONTEXT MODIFICATION REQUIRED | UE CONTEXT MODIFICATION CONFIRM |

FIG. 8 depicts an example binding information transmission with UAVs, in accordance with present implementations. At least UE 104, BS 102, or UAV 402 can perform method 800. At 810, the method 800 can send, by a first wireless communication entity to a second wireless communication entity, a first message, wherein the first message is indicative of binding a first wireless communication device to a second wireless communication device or unbinding the first wireless communication device from the second wireless communication device. At 820, the method 800 can receive, by a first wireless communication from to a second wireless communication entity, a first message, wherein the first message is indicative of binding a first wireless communication device to a second wireless communication device or unbinding the first wireless communication device from the second wireless communication device. At 830, the method 800 can send to the first wireless communication entity by the second wireless communication entity, a second message acknowledging the first message. At 840, the method 800 can receive, by the first wireless communication entity from the second wireless communication entity, a second message acknowledging the first message.

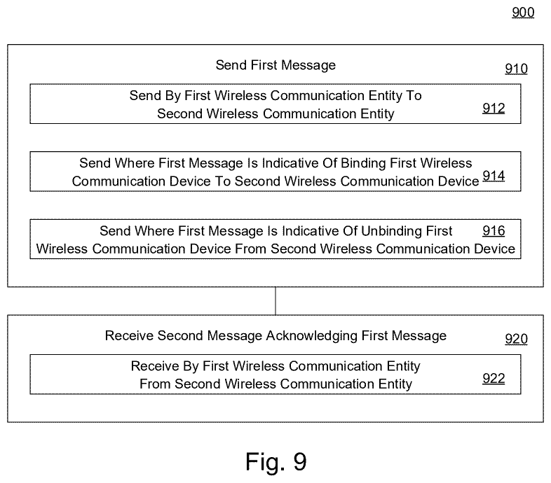

FIG. 9 depicts an example method of binding information transmission with UAVs, in accordance with present implementations. At least UE 104, BS 102, or UAV 402 can perform method 900. At 910, the method 900 can send a first message. At 912, the method 900 can send by a first wireless communication entity to a second wireless communication entity. At 914, the method 900 can send where the first message is indicative of binding a first wireless communication device to a second wireless communication device. At 916, the method 900 can send where the first message is indicative of unbinding the first wireless communication device from the second wireless communication device. At 920, the method 900 can receive a second message acknowledging the first message. At 922, the method 900 can receive by the first wireless communication entity from the second wireless communication entity.

For example, in the wireless communication method, the first message comprises an identification of the first wireless communication device. The method can include an identification of the second wireless communication device. The method can include an indicator indicating that the first wireless communication device and the second wireless communication device should be bound to each other.

For example, in the wireless communication method, the first wireless communication entity is an Access & Mobility Management Function (AM) entity, and the second wireless communication entity is a Next Generation-Random Access Network (NG-RAN) node. For example, in the wireless communication method, each of the first and second messages is a Next Generation Application Protocol (NGAP) message. For example, in the wireless communication method, the first wireless communication entity is a first NG-RAN node, and the second wireless communication entity is a second NG-RAN node.

For example, in the wireless communication method, each of the first and second messages is an Xn Application Protocol (XnAP) message. For example, in the wireless communication method, the first wireless communication entity is a source node, and the second wireless communication entity is a target node. For example, in the wireless communication method, the first wireless communication entity is a master node, and the second wireless communication entity is a slave node.

For example, in the wireless communication method, the first wireless communication entity is a gNodeB-Control Unit (gNB-CU), and the second wireless communication entity is a gNodeB-Distributed Unit (gNB-DU). For example, in the wireless communication method, the first wireless communication entity is a gNodeB-Distributed Unit (gNB-DU), and the second wireless communication entity is a gNodeB-Control Unit (gNB-CU). For example, in the wireless communication method, each of the first and second messages is an F1 Application Protocol (F1AP) message. For example, in the wireless communication method, the first message comprises an identification of the first wireless communication device. The method can include state information of the second wireless communication device. The method can include an indicator indicating that the first wireless communication device and the second wireless communication device should be bound to each other.

For example, in the wireless communication method, the first wireless communication entity is an Access & Mobility Management Function (AMF) entity, and the second wireless communication entity is a Next Generation-Random Access Network (NG-RAN) node. For example, in the wireless communication method, each of the first and second messages is a Next Generation Application Protocol (NGAP) message. For example, in the wireless communication method, the first wireless communication entity is a first NG-RAN node, and the second wireless communication entity is a second NG-RAN node. For example, in the wireless communication method, each of the first and second messages is an Xn Application Protocol (XAP) message. For example, in the wireless communication method, the first wireless communication entity is a source node, and the second wireless communication entity is a target node. For example, in the wireless communication method, the first wireless communication entity is a master node, and the second wireless communication entity is a slave node.

For example, in the wireless communication method, the first wireless communication entity is a gNodeB-Control Unit (gNB-CU), and the second wireless communication entity is a gNodeB-Distributed Unit (gNB-DU). For example, in the wireless communication method, the first wireless communication entity is a gNodeB-Distributed Unit (gNB-DU), and the second wireless communication entity is a gNodeB-Control Unit (gNB-CU). For example, the wireless communication method of claim 19 or 20, where each of the first and second messages is an F1 Application Protocol (F1AP) message. For example, in the wireless communication method, the first message comprises an identification of the first wireless communication device. The method can include an identification of the second wireless communication device and an indicator indicating that the first wireless communication device and the second wireless communication device should be unbound from each other.

For example, in the wireless communication method, the first wireless communication entity is an Access & Mobility Management Function (AMF) entity, and the second wireless communication entity is a Next Generation-Random Access Network (NG-RAN) node. For example, in the wireless communication method, each of the first and second messages is a Next Generation Application Protocol (NGAP) message. For example, in the wireless communication method, the first wireless communication entity is a first NG-RAN node, and the second wireless communication entity is a second NG-RAN node. For example, in the wireless communication method, each of the first and second messages is an Xn Application Protocol (XnAP) message. For example, in the wireless communication method, the first wireless communication entity is a source node, and the second wireless communication entity is a target node. For example, in the wireless communication method, the first wireless communication entity is a master node, and the second wireless communication entity is a slave node.

For example, in the wireless communication method, the first wireless communication entity is a gNodeB-Control Unit (sNB-CU), and the second wireless communication entity is a gNodeB-Distributed Unit (gNB-DU). For example, in the wireless communication method, the first wireless communication entity is a gNodeB-Distributed Unit (gNB-DU), and the second wireless communication entity is a gNodeB-Control Unit (gNB-CU). For example, the wireless communication method of claim 29 or 30, where each of the first and second messages is an F1 Application Protocol (F1AP) message.

At least one aspect is directed to a wireless communication apparatus can include at least one processor and a memory, where the at least one processor is configured to read code from the memory and implement this technical solution. At least one aspect is directed to a computer program product can include a computer-readable program medium code stored thereupon, the code, when executed by at least one processor, causing the at least one processor to implement this technical solution.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
sending, by a first wireless communication entity to a second wireless communication entity, a first message, wherein the first message is indicative of binding a first wireless communication device to a second wireless communication device or unbinding the first wireless communication device from the second wireless communication device; and
receiving, by the first wireless communication entity from the second wireless communication entity, a second message acknowledging the first message.

2. The wireless communication method of claim 1, wherein the first message comprises:
an identification of the first wireless communication device;
an identification of the second wireless communication device; and
an indicator indicating that the first wireless communication device and the second wireless communication device should be bound to each other.

3. The wireless communication method of claim 2, wherein the first wireless communication entity is an Access & Mobility Management Function (AMF) entity, and the second wireless communication entity is a Next Generation-Random Access Network (NG-RAN) node.

4. The wireless communication method of claim 3, wherein each of the first and second messages is a Next Generation Application Protocol (NGAP) message.

5. The wireless communication method of claim 2, wherein the first wireless communication entity is a first NG-RAN node, and the second wireless communication entity is a second NG-RAN node.

6. The wireless communication method of claim 5, wherein each of the first and second messages is an Xn Application Protocol (XnAP) message.

7. The wireless communication method of claim 5, wherein the first wireless communication entity is a source node, and the second wireless communication entity is a target node.

8. The wireless communication method of claim 5, wherein the first wireless communication entity is a master node, and the second wireless communication entity is a slave node.

9. The wireless communication method of claim 2, wherein the first wireless communication entity is a gNodeB-Control Unit (gNB-CU), and the second wireless communication entity is a gNodeB-Distributed Unit (gNB-DU).

10. The wireless communication method of claim 2, wherein the first wireless communication entity is a gNodeB-Distributed Unit (gNB-DU), and the second wireless communication entity is a gNodeB-Control Unit (gNB-CU).

11. The wireless communication method of claim 9, wherein each of the first and second messages is an F1 Application Protocol (F1AP) message.

12. The wireless communication method of claim 1, wherein the first message comprises:
an identification of the first wireless communication device;
state information of the second wireless communication device; and
an indicator indicating that the first wireless communication device and the second wireless communication device should be bound to each other.

13. The wireless communication method of claim 12, wherein the first wireless communication entity is an Access & Mobility Management Function (AMF) entity, and the second wireless communication entity is a Next Generation-Random Access Network (NG-RAN) node.

14. The wireless communication method of claim 13, wherein each of the first and second messages is a Next Generation Application Protocol (NGAP) message.

15. The wireless communication method of claim 12, wherein the first wireless communication entity is a first NG-RAN node, and the second wireless communication entity is a second NG-RAN node.

16. The wireless communication method of claim 15, wherein each of the first and second messages is an Xn Application Protocol (XnAP) message.

17. The wireless communication method of claim 15, wherein the first wireless communication entity is a source node, and the second wireless communication entity is a target node.

18. A first wireless communication entity, comprising:
at least one processor configured to:
send, via a transceiver to a second wireless communication entity, a first message, wherein the first message is indicative of binding a first wireless communication device to a second wireless communication device or unbinding the first wireless communication device from the second wireless communication device; and
receive, via the transceiver from the second wireless communication entity, a second message acknowledging the first message.

19. A wireless communication method, comprising:
receiving, by a second wireless communication entity from a first wireless communication entity, a first message, wherein the first message is indicative of binding a first wireless communication device to a second wireless communication device or unbinding the first wireless communication device from the second wireless communication device; and
transmitting, by the second wireless communication entity to the first wireless communication entity, a second message acknowledging the first message.

20. A second wireless communication entity, comprising:
at least one processor configured to:
receive, via a transceiver from a first wireless communication entity, a first message, wherein the first message is indicative of binding a first wireless communication device to a second wireless communication device or unbinding the first wireless communication device from the second wireless communication device; and
transmit, via the transceiver to the first wireless communication entity, a second message acknowledging the first message.
